(19) United States
(12) Patent Application Publication
(10) Pub. No.: US 2004/0013789 A1
(43) Pub. Date: Jan. 22, 2004

(54) Process for producing tomato flakes

(76) Inventor: Horst Klukowski, Heilbronn (DE)

Correspondence Address: UNILEVER, PATENT DEPARTMENT, 45 RIVER ROAD, EDGEWATER, NJ, 07020, US

(21) Appl. No.: 10/363,784

(22) PCT Filed: Aug. 29, 2001
(86) PCT No.: PCT/EP01/10105

(30) Foreign Application Priority Data
Sep. 7, 2000 (DE) 100 44 244.7

(51) Int. Cl. A23L 1/164

(52) U.S. Cl. 426/621

(57) ABSTRACT

A process for producing tomato flakes that are stable to cooking, by roller-drying an aqueous suspension containing tomato concentrate, starch and pectin or alginate. The flakes are treated with an aqueous solution containing calcium ions.

The invention relates to a process for producing tomato flakes that are stable to cooking. Tomato flakes are taken to mean a semi-manufactured product made of dried tomato pieces. Tomato flakes are required for the production of soups, vegetable mixtures and other prepared dishes. In aqueous suspension they give a tomato pulp, a product that is in paste/piece form. It is essential for the consistency of a tomato pulp, which also determines the organoleptic impression, that the tomato flakes remain in semi-solid form even during cooking. Producing such tomato flakes that are stable to cooking from which, by suspension in an aqueous medium, tomato pulp that is stable to cooking may be produced, is a problem.

German patent application DE-A 199 21 860.9, unpublished at the priority date of the present invention, describes a process for producing dry products which can be reconstituted with cold and hot aqueous liquids to give fruit pulps and vegetable pulps, by roller-drying fruit concentrates and vegetable concentrates containing foreign starch, the flakes obtained by comminution after roller drying being agglomerated using fruit concentrates and vegetable concentrates and the resultant agglomerate being subjected to a heat-moisture treatment. Such a heat-moisture treatment makes it possible to produce flakes and agglomerates that are stable to cooking, but care must be taken during each heat treatment that there is no discoloration or caramelization of the product. The present invention avoids this risk.

The present invention relates to a process for producing tomato flakes that are stable to cooking by roller-drying an aqueous suspension containing tomato concentrate and foreign starch, the flakes obtained by comminution after roller-drying being dried, if appropriate to the desired final water content. According to the invention the suspension is to contain a pectin or sodium alginate and, after the roller-drying, the flakes are treated with an aqueous solution containing calcium ions, preferably a CaCl₂ solution. The pectin or sodium alginate must be added to the suspension if the starting material does not contain, or does not contain sufficient, pectin or sodium alginate.

Pectins and alginates are used generally in food technology as solidifying agents. It is known that their gel properties can be intensified by calcium ions. Thus U.S. Pat. No. 4,163,805 describes a process for producing a reconstituted food product in particular semi-solid pieces of green pepper, in which an aqueous suspension of finely divided green pepper is brought into piece form together with an alginate binder and calcium ions with the conjoint use of a monosaccharide or disaccharide, so that olives can be stuffed with the reconstituted paprika pieces of standard shape.

U.S. Pat. No. 4,504,504 describes a process for preserving the natural texture of diced pectin-containing fresh fruit products or vegetable products by impregnation with an aqueous polyuronic-acid-containing solution and subsequent treatment of the impregnated product with a cation of a divalent metal to effect gelation.

U.S. Pat. No. 4,504,502 describes coating a food product with an alginate, with the conjoint use of calcium ions for protection against moisture.

EP 884 002 A2 describes a process for increasing the consistency of plant products in piece form, in particular diced tomatoes, by treatment with a calcium-complexing mixture containing the enzyme pectinmethylesterase and a calcium salt at elevated temperatures of 60-100° C. In this process, pectin present naturally is demethylated by the enzyme.

This and similar prior art does not indicate how the problem of achieving a pulpy form that is stable to cooking can be achieved with tomato products.

The starting material used is a suitable tomato concentrate, for example three-fold concentrated tomato puree.

Suitable pectins are in particular customary apple pectins, and suitable alginates are, for example, the sodium salts of alginic acid.

The foreign starch used is in particular potato starch. The foreign starch is expediently used in an amount of 10-60% by weight, based on the dry matter of the suspension. However, other starches can be used, such as maize starch, rice starch, wheat starch or tapioca starch.

An aqueous suspension is first produced from the tomato concentrate, the foreign starch and the pectin or alginate. The water content of the suspension is generally 50-75% by weight, preferably 58-68% by weight.

The amount of added pectin or sodium alginate is generally 0.3-5% by weight, preferably 0.5-3% by weight, based on dry matter.

The suspension is subjected to roller-drying, for example at a temperature of 120-160° C. The dry film removed from the roller is comminuted and treated before or after the comminution with an aqueous solution containing calcium ions. Expediently, the flakes removed from the roller are agglomerated in a cutter or agglomerator with a solution containing calcium ions, preferably a CaCl₂ solution.

Expediently, a 0.1-10% strength CaCl₂ solution is used, with the amount of CaCl₂ being set such that it makes up 3-50% by weight, preferably 10-30% by weight, of the amount of pectin or alginate.

Preferably, in addition, a fruit acid, for example citric acid, is added to the suspension.

The starting material used can be a “hot-break” tomato puree, which, in contrast to “cold-break” tomato puree still contains functional pectin. (“Hot-break” denotes a tomato puree in which the pectinase has been inactivated by heat treatment and which therefore still has a high content of functional pectin. In contrast thereto, “cold break” tomato puree, owing to the remaining pectinase activity, contains no pectin, or contains only a small amount of pectin). As a result, the amount of pectin or sodium alginate to be added can be reduced or dispensed with completely.

By agglomerating such flakes with a CaCl₂ solution, an agglomerate that is still more stable to cooking is obtained than when cold-break tomato puree is used.

The inventively produced tomato flakes that are stable to cooking can be converted into a tomato pulp substitute by suspension in an aqueous medium.

### EXAMPLE

A suspension is produced from the following constituents:

| | |
|---|---|
| Amount used | DM basis |

| | | | | |
|---|---|---|---|---|
| Tomato puree, 3-tuply concen- | 200.00 | kg | 76.0 | kg |
| trated | | | | |
| Potato starch | 100.00 | kg | 80.0 | kg |
| Na alginate or apple pectin | 2.00 | kg | 2.0 | kg |
| Citric acid | 1.70 | kg | 1.7 | kg |
| Water | 135.00 | kg | | |
| Total 1 | 438.00 | kg | 159.7 | kg |

The suspension is roller-dried at a roller temperature of 140° C. and the dry film removed from the roller is agglomerated in a “Seydelmann Cutter” with addition of a 1% strength aqueous CaCl₂ solution.

| | |
|---|---|
| Amount used | DM basis |

| | | | | |
|---|---|---|---|---|
| Dried tomato flakes | 1000.0 | g | 980.0 | g |
| CaCl₂ solution 1% strength | 300.0 | g | 3.0 | g |
| Total 2 | 1300.0 | g | 983.0 | g |

(DM = dry matter)

The agglomerate is gently further dried to a moisture content of 4% by weight at a product temperature of 65° C.

1. Process for producing tomato flakes that are stable to cooking by roller-drying an aqueous suspension containing tomato concentrate and foreign starch, characterized in that the suspension contains pectin or sodium alginate and, after the roller-drying, the flakes are treated with an aqueous solution containing calcium ions.

2. Process according to claim 1, characterized in that the flakes obtained by comminution after roller-drying are dried to the desired final water content.

3. Process according to claim 1 or 2, characterized in that the suspension contains 0.3-5% by weight, preferably 0.5-3% by weight, pectin or sodium alginate based on dry matter.

4. Process according to one of the preceding claims, characterized in that the flakes are treated, after the roller-drying, with a 0.1-10% strength CaCl₂ solution, the amount of CaCl₂ making up 3-50% by weight, preferably 10-30% by weight, of the amount of pectin or alginate.

5. Process according to one of the preceding claims, characterized in that the flakes removed from the roller are agglomerated in a cutter or agglomerator with an aqueous solution containing calcium ions.

6. Process according to one of the preceding claims, characterized in that, in addition, a fruit acid is added to the suspension.

7. Process according to one of the preceding claims, characterized in that, to produce the starting suspension, a tomato puree is used that still contains functional pectin.

8. Process according to one of the preceding claims, characterized in that the foreign starch used is potato starch.

9. Process according to one of the preceding claims, characterized in that the foreign starch is added to the suspension in an amount of 10-60% by weight, based on dry matter.

10. Tomato pulp substitute produced by suspending in aqueous medium the tomato flakes produced according to one of claims 1-9.

11. Use of tomato flakes produced according to one of claims 1-9 in aqueous suspension as tomato pulp substitute.
